(19) United States
(12) Patent Application Publication
(10) Pub. No.: US 2021/0171280 A1
(43) Pub. Date: Jun. 10, 2021

(54) GARBAGE CONTAINER

(71) Applicant: Michael SHEK, San Mateo, CA (US)

(72) Inventor: Michael SHEK, San Mateo, CA (US)

(21) Appl. No.: 16/707,342

(22) Filed: Dec. 9, 2019

(51) Int. Cl. B65F 1/06; B65F 1/14

(52) U.S. Cl. CPC B65F 1/062; B65F 1/1426

(57) ABSTRACT

A garbage container is provided, including: a main body and a storage box. The storage box is detachably positioned on and out of the main body and includes a casing, an inlet and an outlet. The casing defines a receiving space configured to receive at least one roll of garbage bags including a plurality of garbage bags connected with one another. The inlet and the outlet communicate the receiving space with an exterior of the receiving space, and the inlet is disposed on an upper portion of the casing and configured for the at least one roll of garbage bags to pass therethrough and into the receiving space. The outlet is disposed on a lower portion of the casing and is an elongate slit, and the outlet is configured for one of the plurality of garbage bags to pass therethrough and protrude out of the casing.

### BACKGROUND OF THE INVENTION

### Field of the Invention

The present invention relates to a garbage container.

### Description of the Prior Art

Generally, a garbage bag is placed in a barrel of the garbage container, which is convenient for packing garbage and keeps the barrel clean. For easy operation, a garbage container receiving garbage bags in its bottom is developed, and when the garbage bag in used is full, an unused garbage bag is directly pulled up to use, such garbage containers are disclosed in TWM574602, TWM525915, TWM517731 and TWM478012.

However, when the garbage bag in used is broken, the garbage in the garbage bag is easy to smudge the unused garbage bags received in the barrel, which results problems of cleaning and waste. Moreover, each of the garbage containers as described above requires a roll of garbage bags to be disposed therein so that multiple rolls of garbage bags have to be prepared. The roll of garbage bags is embedded in the barrel, and the garbage bag in used has to be taken out so as to take the unused garbage bag, which is impractical and inconvenient.

The present invention is, therefore, arisen to obviate or at least mitigate the above-mentioned disadvantages.

### SUMMARY OF THE INVENTION

The main object of the present invention is to provide a garbage container which is convenient to take and replace a garbage bag and can keep unused garbage bags clean.

To achieve the above and other objects, the present invention provides a garbage container, including: a main body and a storage box. The storage box is detachably positioned on and out of the main body and includes a casing, an inlet and an outlet. The casing defines a receiving space configured to receive at least one roll of garbage bags which includes a plurality of garbage bags connected with one another. The inlet and the outlet communicate the receiving space with an exterior of the receiving space, and the inlet is disposed on an upper portion of the casing and configured for the at least one roll of garbage bags to pass therethrough and into the receiving space. The outlet is disposed on a lower portion of the casing and is an elongate slit, and the outlet is configured for one of the plurality of garbage bags to pass therethrough and protrude out of the casing.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram of a preferable embodiment of the present invention;

FIG. 2 is a breakdown drawing of FIG. 1;

FIG. 3 is a front view of a preferable embodiment of the present invention;

FIG. 4 is a schematic diagram of a preferable embodiment of the present invention when a roll of garbage bags is put into a storage box;

FIG. 5 is a schematic diagram of a preferable embodiment of the present invention in use;

FIG. 6 is a partial cross-sectional view of FIG. 5;

FIG. 7 is a partial enlargement of FIG. 6.

### DETAILED DESCRIPTION OF THE PREFERRED EMBODIMENTS

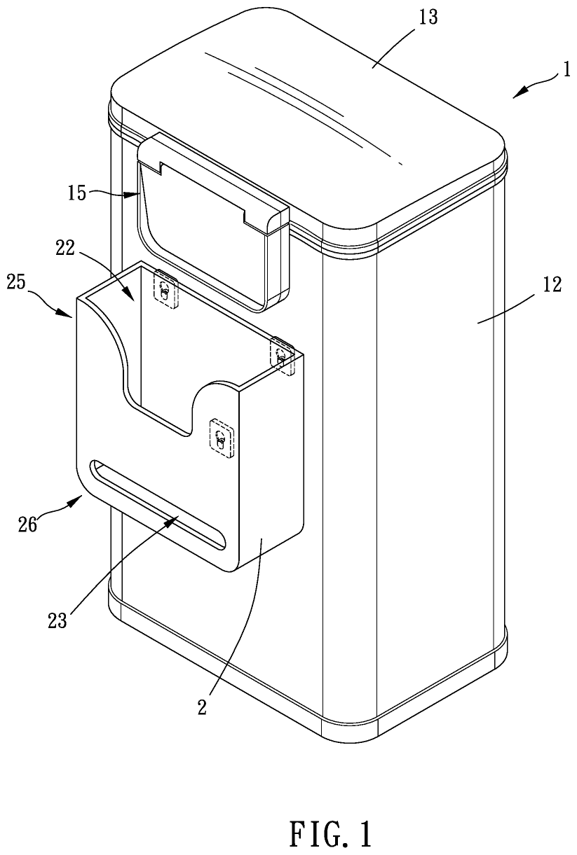

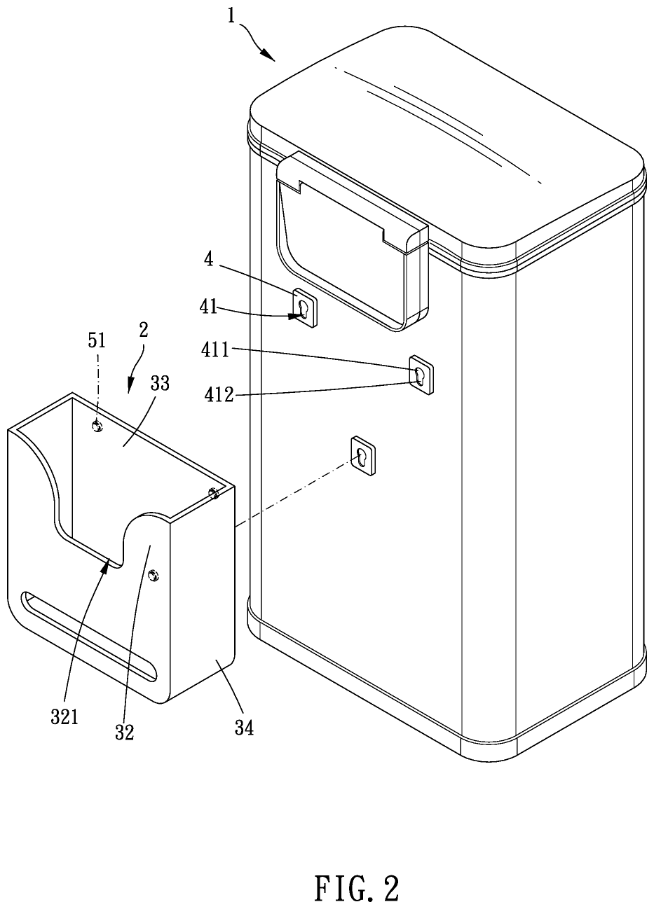

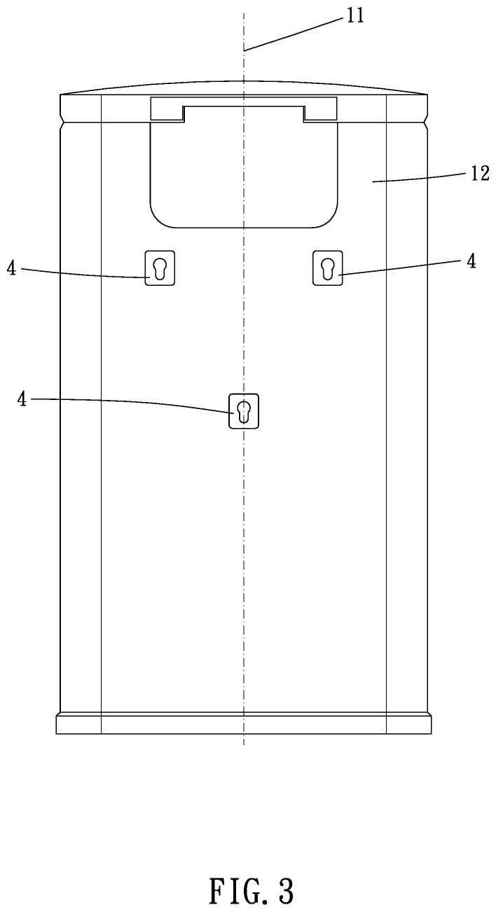

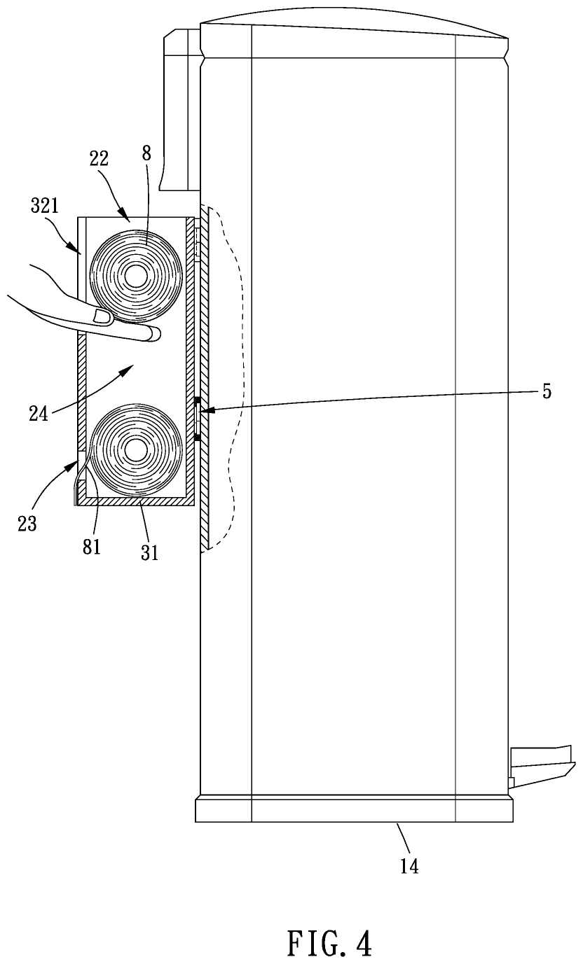

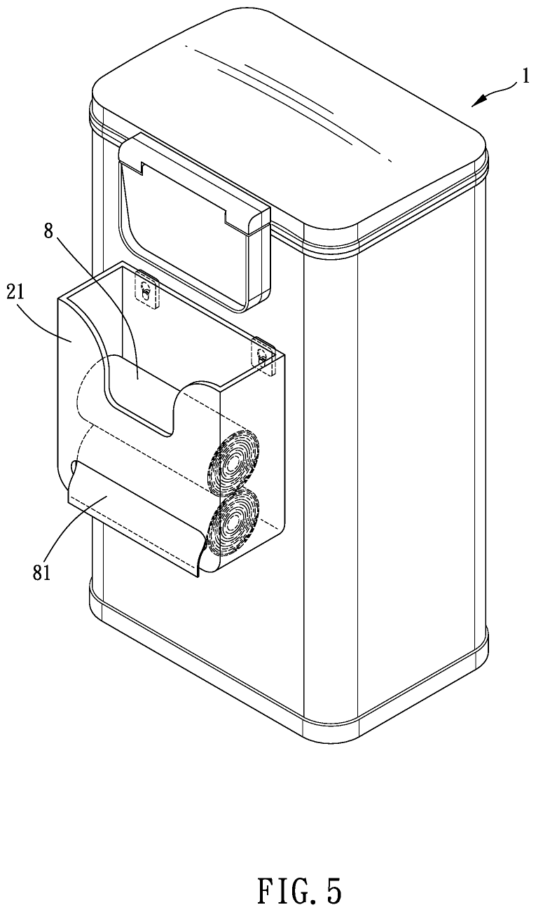

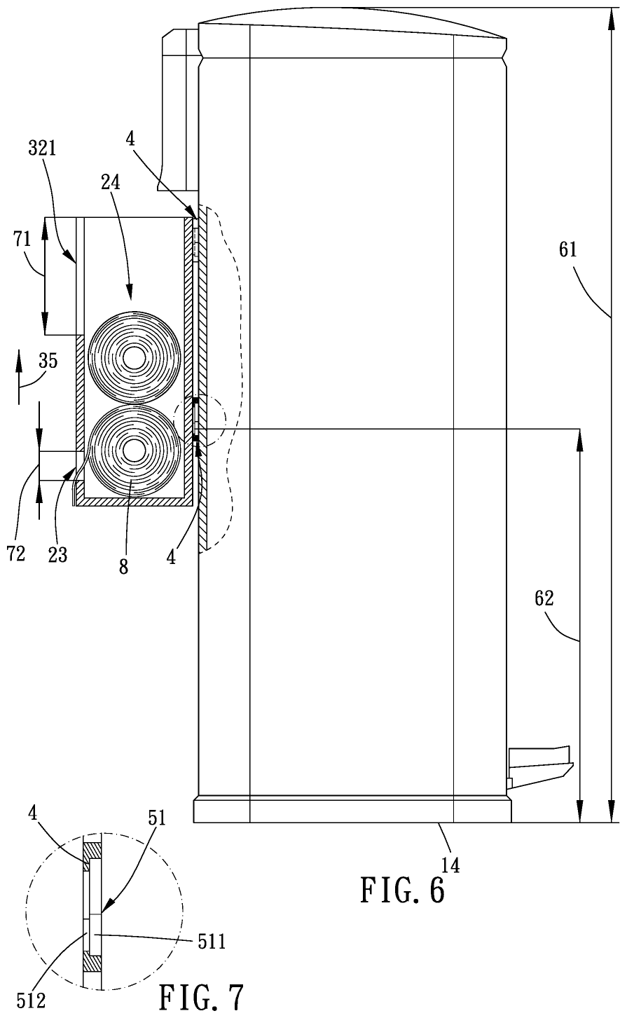

Please refer to FIGS. 1 to 7 for a preferable embodiment of the present invention. A garbage container 1 of the present invention includes a main body 1 and a storage box 2.

The storage box 2 is detachably positioned on and out of the main body 1 so that the storage box 2 and the main body 1 can be cleaned separately, and it is convenient to storage. The storage box 2 includes a casing 21, an inlet 22 and an outlet 23, and the casing 21 defines a receiving space 24 configured to receive at least one roll of garbage bags 8 which includes a plurality of garbage bags 81 connected with one another. The inlet 22 and the outlet 23 communicate the receiving space 24 with an exterior of the receiving space 24. The inlet 22 is disposed on an upper portion 25 of the casing 21 and configured for the at least one roll of garbage bags 8 to pass therethrough and into the receiving space 24. The outlet 23 is disposed on a lower portion 26 of the casing 21 and is an elongate slit, and the outlet 23 is configured for one of the plurality of garbage bags 81 to pass therethrough and protrude out of the casing 21.

The storage box 2 is disposed out of the main body 1 and separated from a garbage bag in the main body 1 so as to avoid contamination. When the garbage bag in the main body 1 is full, one of the plurality of garbage bags 81 is taken out from the outlet 23 to replace the garbage bag in the main body 1, which is convenient to use.

Preferably, the storage box 2 further includes a notch 321, and the notch 321 is disposed on the casing 21 and communicated with the inlet 22 and laterally communicated with the receiving space 24. Therefore, the notch 321 allows a user to observe the receiving space 24 and determine whether to supply the at least one roll of garbage bags 8. The user's hand can enter into the receiving space 24 through the notch 321 and the at least one roll of garbage bags 8 is dropped when its position is close to the lower portion 26 of the casing 21 so as to reduce force exerted on the casing 21, prevent the main body 1 from shaking and avoid damage to the casing 21. The notch 321 also allows the user's hand to enter into the receiving space 24 to take, place or adjust the at least one roll of garbage bags 8. Moreover, the storage box 2 is large enough to receive multiple rolls of garbage bags 8, boxes of garbage bag and various sizes of garbage bags.

In a height direction 35 of the storage box 2, a maximum distance of the notch 321 is defined as a first length 71, a maximum distance of the outlet 23 is defined as a second length 72, and a ratio of the second length 72 to the first length 71 is between 0.1 and 0.3. Therefore, the outlet 23 has a suitable size for the at least one roll of garbage bags 8 with a normal size to pass therethrough and the casing 21 has sufficient structural strength.

The main body 1 includes a barrel 12, a cover 13 and a pivot structure 15. The cover 13 is openably disposed on the barrel 12 by the pivot structure 15, and the storage box 2 is preferably disposed below the pivot structure 15. The storage box 2 is located at a backside of the barrel 12 so as to keep the at least one roll of garbage bags 8 clean. Moreover, in the height direction 35 of the storage box 2, a ratio of a height of the storage box 2 to a height of the main body 1 is between 0.25 and 0.45, so that sizes of the storage box 2 and the main body 1 are preferably cooperative and the receiving space 24 has a sufficient size.

The main body 1 further includes at least one first positioning portion 4, and the storage box 2 further includes at least one second positioning portion 5. A number of the at least one second positioning portion 5 is equal to a number of the at least one first positioning portion 4, and the at least one first positioning portion 4 is releasably engaged with the at least one second positioning portion 5.

Furthermore, one of the at least one first positioning portion 4 and the at least one second positioning portion 5 has an engaging concave 41, and the other of the at least one first positioning portion 4 and the at least one second positioning portion 5 has an engaging convex 51. The engaging convex 51 is inserted and engaged within the engaging concave 41. The engaging concave 41 includes a large-diameter hole 411 and a small-diameter hole 412 which are communicated with each other, and the small-diameter hole 412 is located below the large-diameter hole 411; the engaging convex 51 includes an engaging portion 511 and a necked portion 512 which are connected with each other, and the engaging portion 511 is inserted within the large-diameter hole 411 and moved to the small-diameter hole 412, and the necked portion 512 is engaged with a circumferential wall of the small-diameter hole 412 for stable connection.

In this embodiment, the storage box 2 includes three said first positioning portions 4, two of the three said first positioning portions 4 are spacingly aligned with each other, and another one of the three said first positioning portions 4 is located below the two of the three said first positioning portions 4. As viewed in a direction facing the three said first positioning portions 4, the three said first positioning portions 4 are symmetrically arranged relative to a central line 11 of the main body 1. A height of the main body 1 is defined as a first height 61, a distance between the another one of the three said first positioning portions 4 disposed below the two of the three said first positioning portions 4 and a bottom surface 14 of the main body 1 is defined as a second height 62, and a ratio of the second height 62 to the first height 61 is between 0.4 and 0.6.

Moreover, the casing 21 further includes a bottom wall 31, a first side wall 32, a second side wall 33 and two connecting side walls 34. The first side wall 32, the second side wall 33 and the two connecting side walls 34 are laterally connected with the bottom wall 31, and the inlet 22 faces toward the bottom wall 31. The first side wall 32 and the second side wall 33 face each other, and the two connecting side walls 34 respectively connected between the first side wall 32 and the second side wall 33. The first side wall 32 is remote from the main body 1 and has the outlet 23, and the second side wall 33 faces toward the main body 1 and has the at least one second positioning portion 5. In this embodiment, the storage box 2 includes three said second positioning portions 5, two of the three said second positioning portions 5 are disposed on the upper portion 25, and another one of the three said second positioning portions 5 is disposed on the lower portion 26 and higher than the outlet 23.

Specifically, in the height direction 35 of the storage box 2, a ratio of a distance, between one of the three said second positioning portions 5 disposed on the upper portion 25 and the another one of the three said second positioning portions 5 disposed on the lower portion 26, to the height of the storage box 2 is between 0.5 and 0.7 so that the storage box 2 is stably disposed on the barrel 12.

In summary, the storage box of the garbage container can be used to receive the at least one roll of garbage bags which are unused, which is convenient to replace the garbage bag in the main body. Moreover, the storage box is detachably disposed on the main body so as to be convenient for cleaning and storage. The notch allows the user to observe the receiving space and take or place the at least one roll of garbage bags, which is convenient to use.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A garbage container, including:
a main body;
a storage box, being detachably positioned on and out of the main body, including a casing, an inlet and an outlet, the casing defining a receiving space configured to receive at least one roll of garbage bags which includes a plurality of garbage bags connected with one another, the inlet and the outlet communicating the receiving space with an exterior of the receiving space, the inlet being disposed on an upper portion of the casing and configured for the at least one roll of garbage bags to pass therethrough and into the receiving space, the outlet being disposed on a lower portion of the casing and being an elongate slit, the outlet being configured for one of the plurality of garbage bags to pass therethrough and protrude out of the casing.

2. The garbage container of claim 1, wherein the main body further includes at least one first positioning portion, the storage box further includes at least one second positioning portion, a number of the at least one second positioning portion is equal to a number of the at least one first positioning portion, and the at least one first positioning portion is releasably engaged with the at least one second positioning portion.

3. The garbage container of claim 2, wherein one of the at least one first positioning portion and the at least one second positioning portion has an engaging concave, the other of the at least one first positioning portion and the at least one second positioning portion has an engaging convex, and the engaging convex is inserted and engaged within the engaging concave.

4. The garbage container of claim 2, wherein the main body includes three said first positioning portions, two of the three said first positioning portions are spacingly aligned with each other, another one of the three said first positioning portions is located below the two of the three said first positioning portions; as viewed in a direction facing the three said first positioning portions, the three said first positioning portions are symmetrically arranged relative to a central line of the main body.

5. The garbage container of claim 4, wherein the storage box includes three said second positioning portions, two of the three said second positioning portions are disposed on the upper portion, and another one of the three said second positioning portions is disposed on the lower portion and higher than the outlet.

6. The garbage container of claim 5, wherein a height of the main body is defined as a first height, a distance between the another one of the three said first positioning portions disposed below the two of the three said first positioning portions and a bottom surface of the main body is defined as a second height, and a ratio of the second height to the first height is between 0.4 and 0.6.

7. The garbage container of claim 2, wherein the casing further includes a bottom wall, a first side wall, a second side wall and two connecting side walls, the first side wall, the second side wall and the two connecting side walls are laterally connected with the bottom wall, the inlet faces toward the bottom wall, the first side wall and the second side wall face each other, the two connecting side walls are respectively connected between the first side wall and the second side wall; the first side wall is remote from the main body and has the outlet, and the second side wall faces toward the main body and has the at least one second positioning portion.

8. The garbage container of claim 1, wherein the storage box further includes a notch, and the notch is disposed on the casing and communicated with the inlet and laterally communicated with the receiving space.

9. The garbage container of claim 8, wherein in a height direction of the storage box, a maximum distance of the notch is defined as a first length, a maximum distance of the outlet is defined as a second length, and a ratio of the second length to the first length is between 0.1 and 0.3.

10. The garbage container of claim 6, wherein one of the at least one first positioning portion and the at least one second positioning portion has an engaging concave, the other of the at least one first positioning portion and the at least one second positioning portion has an engaging convex, and the engaging convex is inserted and engaged within the engaging concave; the casing further includes a bottom wall, a first side wall, a second side wall and two connecting side walls, the first side wall, the second side wall and the two connecting side walls are laterally connected with the bottom wall, the inlet faces toward the bottom wall, the first side wall and the second side wall face each other, the two connecting side walls respectively connected between the first side wall and the second side wall; the first side wall is remote from the main body and has the outlet, and the second side wall faces toward the main body and has the at least one second positioning portion; the storage box further includes a notch, and the notch is disposed on the casing and communicated with the inlet and laterally communicated with the receiving space; in a height direction of the storage box, a maximum distance of the notch is defined as a first length, a maximum distance of the outlet is defined as a second length, and a ratio of the second length to the first length is between 0.1 and 0.3; the main body includes a barrel, a cover and a pivot structure, the cover is openably disposed on the barrel by the pivot structure, the storage box is located below the pivot structure; in the height direction of the storage box, a ratio of a height of the storage box to a height of the main body is between 0.25 and 0.45; in the height direction of the storage box, a ratio of a distance, between one of the three said second positioning portions disposed on the upper portion and the another one of the three said second positioning portions disposed on the lower portion, to the height of the storage box is between 0.5 and 0.7; the engaging concave includes a large-diameter hole and a small-diameter hole which are communicated with each other, the small-diameter hole is located below the large-diameter hole, the engaging convex includes an engaging portion and a necked portion which are connected with each other, the engaging portion is inserted within the large-diameter hole and moved to the small-diameter hole, and the necked portion is engaged with a circumferential wall of the small-diameter hole.
